(19) United States
(12) Patent Application Publication
(10) Pub. No.: US 2013/0321643 A1
(43) Pub. Date: Dec. 5, 2013

(54) IMAGE DISPLAY DEVICE AND OBJECT DETECTION DEVICE

(71) Applicants: Nobuhiro Fujinawa, Yokohama-shi (JP); Hidenori Kuribayashi, Tokyo (JP)

(72) Inventors: Nobuhiro Fujinawa, Yokohama-shi (JP); Hidenori Kuribayashi, Tokyo (JP)

(73) Assignee: NIKON CORPORATION, Tokyo (JP)

(21) Appl. No.: 13/985,222

(22) PCT Filed: Mar. 16, 2012
(86) PCT No.: PCT/JP2012/056838

§ 371 Date: Aug. 13, 2013

(30) Foreign Application Priority Data
Mar. 31, 2011 (JP) 2011-080355
Mar. 31, 2011 (JP) 2011-080356
Mar. 31, 2011 (JP) 2011-080357

(51) Int. Cl. G06F 3/00

(52) U.S. Cl. CPC G06F 3/005
USPC 348/169; 345/156

(57) ABSTRACT

An image display device is provided with: a display having a display screen; a shooting unit that is arranged on an external side of the display screen so that an optical axis obliquely intersects a normal line of the display screen (for example, the normal line passing through the center) on a front surface side of the display screen and sequentially shoots images in a direction of the optical axis to capture shooting images; and a detection unit that detects a change of the shooting images shot by the shooting unit.

### TECHNICAL FIELD

The present invention relates to an image display device and an object detection device.

### BACKGROUND ART

There have been proposed image display devices including a camera at the outer frame of a display screen and allowing a motion operation according to the motion of a hand of a user (for example, Patent Literature 1). In such an image display device, a light emission unit is provided adjacent to a camera and caused to blink in synchronization with the frame rate of the camera. The image display device detects the hand of the user as an object by calculating a difference between an image shot in a state in which the light emission unit is caused to emit light and an image shot in a state in which the light emission unit is caused to turn off.

### CITATION LIST

### Patent Literature

Patent Literature 1: JP 2010-81466 A

### SUMMARY OF INVENTION

### Technical Problem

However, in the related art, the camera shoots not only the hand of the user but also a background behind the user, which results in the likelihood of erroneously detecting motion other than the motion of the hand of the user. Particularly, there has been a problem in that the erroneous detection is highly likely to be caused by the motion in the background (such as when a person cuts across the background).

In addition, if blinking illumination such as a fluorescent bulb and LED illumination exists in the view field of the camera, an image related to the illumination may remain as a differential image in the related art, which has given rise to a problem that the detection accuracy of the hand of the user as an object may be degraded.

It is an object of the present invention to improve the detection accuracy of a motion operation by a user.

### Solution to Problem

An image display device according to a first aspect of the present invention includes: a display having a display screen; a shooting unit that is arranged on an external side of the display screen so that an optical axis obliquely intersects a normal line of the display screen on a front surface side of the display screen and sequentially shoots images in a direction of the optical axis to capture shooting images; and a detection unit that detects a change of the shooting images shot by the shooting unit.

An image display device according to a second aspect of the present invention includes: a display having a display screen; an illumination unit arranged on an external side of the display screen so that a light beam of illumination light obliquely intersects a normal line of the display screen on a front surface side of the display screen; and a shooting unit that sequentially shoots images in a front surface direction of the display screen to capture shooting images.

An object detection device according to a third aspect of the present invention includes: a shooting unit that sequentially shoots images at a prescribed frame rate to capture shooting images; an illumination unit that emits illumination light for shooting with the shooting unit; and a control unit that performs switching control so that the illumination unit selectively emits light between at first light intensity and at second light intensity less than the first light intensity.

### Advantageous Effects of Invention

According to the present invention, the detection accuracy of a motion operation by a user can be improved.

### BRIEF DESCRIPTION OF DRAWINGS

FIG. 1 is a side view schematically showing a digital photo frame according to an embodiment of the present invention and a user operating the digital photo frame.

FIG. 2 is a front view of the digital photo frame according to the embodiment of the present invention.

FIG. 3 is a block diagram showing the configuration of a control unit of the digital photo frame according to the embodiment of the present invention.

FIG. 4 is a flow chart showing the processing of the processing unit of the digital photo frame according to the embodiment of the present invention.

FIG. 5 is a side view showing a first modified example of the digital photo frame according to the embodiment of the present invention.

FIG. 6 is a side view showing the first modified example of the digital photo frame according to the embodiment of the present invention.

FIG. 7 is a side view showing a second modified example of the digital photo frame according to the embodiment of the present invention.

FIG. 8 is a side view showing the second modified example of the digital photo frame according to the embodiment of the present invention.

FIG. 9 is a side view showing the digital photo frame according to another embodiment of the present invention.

FIG. 10 is a side view showing a first modified example of the digital photo frame according to another embodiment of the present invention.

FIG. 11 is a side view showing a second modified example of the digital photo frame according to another embodiment of the present invention.

FIG. 12 is a side view showing a third modified example of the digital photo frame according to another embodiment of the present invention.

FIG. 13 is a diagram showing the light emission timing and the change of the light intensity of infrared light in first object detection processing according to the embodiment of the present invention.

FIG. 14 is a diagram for describing the first object detection processing according to the embodiment of the present invention.

FIG. 15 is a diagram showing the light emission timing and the change of the light intensity of infrared light in second object detection processing according to the embodiment of the present invention.

FIG. 16 is a diagram for describing the second object detection processing according to the embodiment of the present invention.

FIG. 17 is a diagram showing the light emission timing and the change of the light intensity of infrared light in third object detection processing according to the embodiment of the present invention.

FIG. 18 is a diagram for describing the third object detection processing according to the embodiment of the present invention.

FIG. 19 is a diagram showing the light emission timing and the change of the light intensity of infrared light in fourth object detection processing according to the embodiment of the present invention.

FIG. 20 is a diagram for describing the fourth object detection processing according to the embodiment of the present invention.

### DESCRIPTION OF EMBODIMENTS

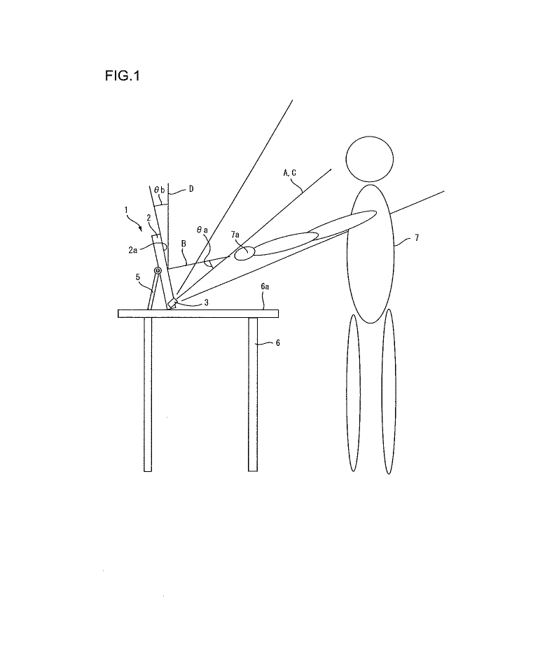

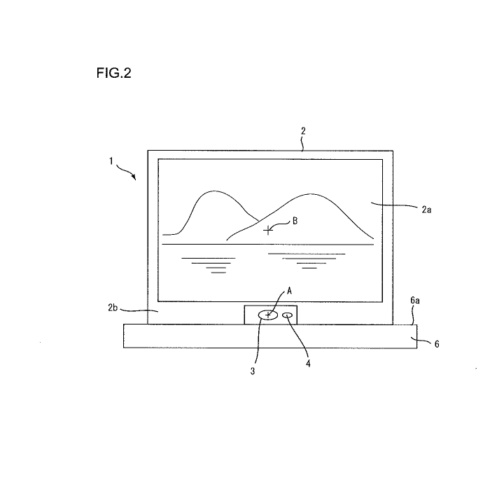

Hereinafter, taking a digital photo frame as an example of an image display device to which the present invention is applied, embodiments of the present invention will be described. First, reference will be made to FIGS. 1 and 2. A digital photo frame 1 of this embodiment is configured to roughly include a display 2 having a substantially rectangular display screen 2a and a camera 3 serving as a shooting unit. As the display 2, a liquid crystal panel can be, for example, used.

Although not shown, the camera 3 includes an image sensor such as a CCD that shoots an image of an object and a lens that forms the image of the object on the image forming surface of the image sensor. According to the embodiment, the camera 3 is integrally fixed at the substantially central area of the lower side part of a frame (frame member) arranged at the periphery of the display screen 2a on the front side of the display 2, and mainly shoots as an object a hand 7a of a user 7 facing the digital photo frame 1. The camera 3 is arranged on the external side of the display screen 2a so that the direction (orientation direction) of its optical axis A obliquely intersects the direction of a normal line passing through the display screen 2a on the front surface (front) side of the display screen 2a. Here, assuming that an angle formed by the optical axis A of the camera 3 and a normal line B passing through the center (or an area near the center) of the display screen 2a is θa and an angle formed by the display screen 2a and a normal line D of a mounting surface 6a is θb, it is preferable to establish the relationship θa+θb=70°±10° if θb is in the range of 0° to 40°, the relationship θa=30°±10° if θb is in the range of 40° to 60°, and the relationship θa+θb=90°±10° if θb is in the range of 60° to 90°.

According to the embodiment, an LED 4 that emits infrared light as illumination light for shooting images with the camera 3 is provided adjacent to the camera 3. The LED 4 is fixed to a frame 2b so that the direction (direction of a main light beam) of its optical axis substantially corresponds to (i.e., substantially parallel to) the direction of the optical axis A of the camera 3. However, as will be described later, the direction of the optical axis of the LED 4 may be set to be different from that of the optical axis A of the camera 3. Note that the LED 4 may emit visible light rather than emitting infrared light.

On the rear surface side of the display 2, a stand 5 serving as a display supporting member for mounting the display 2 on the mounting surface 6a (upper surface of a table 6) is rotatably attached. When the stand 5 is rotated in an opening or closing direction relative to the rear surface of the display 2 to be set at any angle within a prescribed angle range, the inclination angle of the display screen 2a relative to the mounting surface 6a can be changed.

The digital photo frame 1 is mounted on the mounting surface 6a in a prescribed position in such a manner that the lower side of the frame 2b and the lower end of the stand 5 are placed in contact with the mounting surface 6a. Note that the camera 3 and the LED 4 are fixed to the frame 2b according to the embodiment. Therefore, when the angle of the stand 5 is adjusted to change the inclination angle of the display screen 2a relative to the mounting surface 6a, the angles of the optical axis A of the camera 3 and the optical axis C of the LED 4 relative to the mounting surface 6a are also changed correspondingly. Note that even if the inclination angle of the display screen 2a relative to the mounting surface 6a is changed, the angles θa of the optical axis A of the camera 3 and the optical axis C of the LED 4 relative to the normal line B passing through the center of the display screen 2a are not changed.

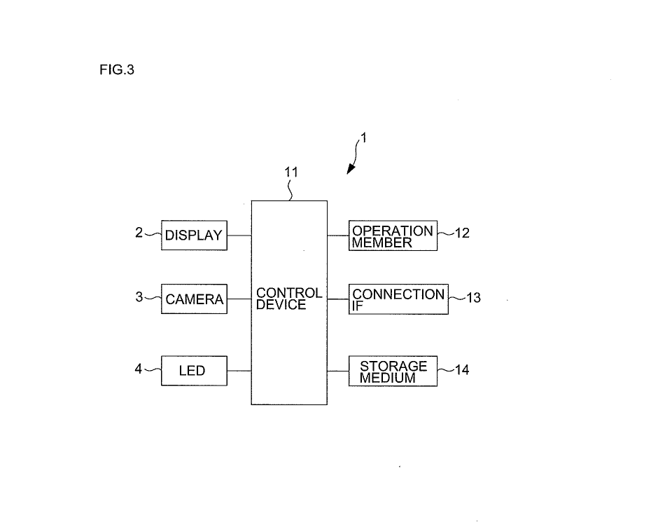

As shown in FIG. 3, the digital photo frame 1 includes a control device 11 that controls the display 2, the camera 3, and the LED 4, and the control device 11 is connected to an operation member 12, a connection IF 13, and a storage medium 14.

The control device 11 is constituted of a CPU, a memory, and other peripheral circuits, and controls the entirety of the digital photo frame 1. Note that the memory constituting the control device 11 is, for example, a volatile memory such as a SDRAM. Examples of the memory include a work memory in which the CPU develops a program at the execution of the program and a buffer memory in which data is temporarily stored.

The control device 11 generates image data based on an image signal output from the image sensor of the camera 3. In addition, the control device 11 controls the lighting or lighting (light emission) intensity of the LED 4 or the turn-off of the LED 4 for shooting with the camera 3.

The operation member 12 includes an operation button or the like operated by the user 7 of the digital photo frame 1. The connection IF 13 is an interface for the connection of the digital photo frame 1 to an external device. According to the embodiment, the digital photo frame 1 is connected via the connection IF 13 to an external device, for example, a digital camera or the like having image data recorded thereon. Then, the control device 11 captures image data from the external device via the connection IF 13 and records the same on the storage medium 14. Note that as the connection IF 13, an USB interface for the wired connection of the external device to the digital photo frame 1, a wireless LAN module for the wireless connection of the external device to the digital photo frame 1, or the like is used. Alternatively, it may also be possible to provide a memory card slot instead of the connection IF 13 and insert a memory card having image data recorded thereon in the memory card slot to capture the image data.

The storage medium 14 is a non-volatile memory such as a flash memory, and records thereon a program executed by the control device 11 and image data or the like captured via the connection IF 13.

In the digital photo frame 1 according to the embodiment, the control device 11 detects the position of the hand 7a of the user 7 and the change of the position between frames based on images shot by the camera 3, and changes the reproduction status of the display image 2a on the display 2 according to the detection result. As the change of the reproduction status, image forwarding (an image currently displayed is changed to an image to be next displayed) or image replaying (an image currently displayed is changed to an image previously displayed) can be, for example, exemplified. Hereinafter, a description will be given of the change processing of the reproduction status of an image with the control device 11 according to the position of the hand 7a of the user 7 and the change of the position between frames.

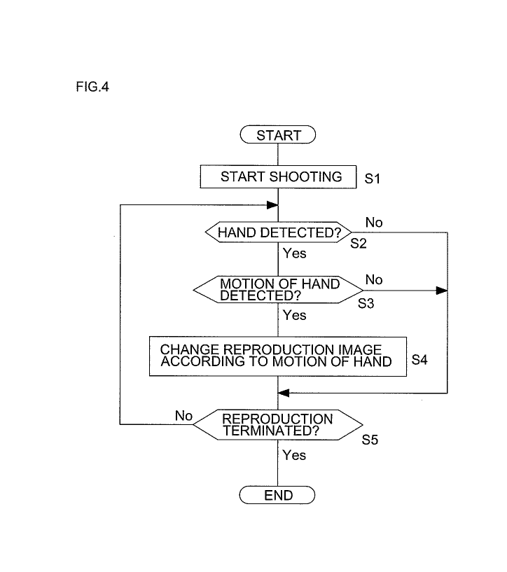

FIG. 4 is a flowchart showing the flow of the change processing of the reproduction status of an image according to the position of the hand 7a of the user 7 and the change of the position between frames. The processing shown in FIG. 4 is executed by the control device 11 as a program activating when the reproduction and display of an image on the display 2 is started.

In step S1, the control device 11 starts shooting an image with the camera 3. Here, the camera 3 performs the shooting at a prescribed frame rate (for example, 30 fps), and the control device 11 processes image data successively input from the camera 3 at a prescribed time interval corresponding to the frame rate. In addition, the LED 4 is not caused to light up. However, the control device 11 may cause the LED 4 to light up to capture an image for one frame and then cause the LED 4 to turn off to capture an image for one frame and perform the differential calculation of these images to process image data related to an image (image of a difference) corresponding to the difference. By the processing of such an image of the difference, the influence of disturbance caused in the background of the shooting image can be reduced. Note that the above processing for controlling the lighting or the like of the LED 4 to improve the detection accuracy of an object (object detection processing) will be described later. Then, the control device 11 proceeds to step S2.

In step S2, the control device 11 determines whether the hand 7a of the user 7 in the image has been detected, based on the image data (image data related to the image of the difference if the differential calculation is performed) input from the camera 3. For example, in a state in which the image of the hand 7a of the user 7 is recorded in advance as a template image, the control device 11 performs the matching of an object image and the template image to determine whether the hand 7a of the user 7 has been reflected in the object image. If so, the control device 11 detects the position of the hand 7a. In step S2, the control device 11 proceeds to step S3 if the position of the hand 7a has been detected (Yes) or proceeds to step S5 if the hand 7a has not been detected (No).

In step S3, the control device 11 monitors the change of the position of the hand 7a in the image between the image data (image data related to the image of the difference chronologically calculated if the differential calculation is performed) chronologically input from the camera 3 to detect the motion of the hand 7a of the user 7. If the motion of the hand 7a of the user 7 has not been detected in step S3 (No), the control device 11 proceeds to step S5. Conversely, if the motion of the hand 7a of the user 7 has been detected in step S3 (Yes), the control device 11 proceeds to step S4.

In step S4, the control device 11 changes a reproduction image according to the motion of the hand 7a. In other words, when it is detected that the hand 7a has been moved from right to left, the control device 11 determines that the user 7 has instructed the image forwarding. Here, the control device 11 displays an image currently displayed on the display 2 so as to move leftward and leave the screen from the left side of the screen, and then displays on the display 2 an image to be next displayed so as to move in the screen from the right side of the screen.

Conversely, when it is detected that the hand 7a has been moved from left to right, the control device 11 determines that the user 7 has instructed the image replaying. Here, the control device 11 displays the image currently displayed on the display 2 so as to move rightward and leave the screen from the right side of the screen, and then displays on the display 2 the previously-displayed image so as to move in the screen from the left side of the screen.

Note here that although the image forwarding or the image replaying is performed according to the horizontal motion of the hand 7a of the user 7, other processing may be performed with the detection of other motions. For example, a cursor having a prescribed shape may be displayed in the screen corresponding to the position of the hand 7a of the user 7 and moved in the screen according to the motion of the hand 7a to select an instructing and inputting icon or the like displayed in the screen. In addition, the vertical motion of the hand 7a may be, for example, detected to change the display magnification of the image.

Subsequently, in step S5, the control device 11 determines whether the user 7 has instructed the termination of the image reproduction. In step S5, the control device 11 returns to step S2 if the termination has not been instructed (No) or terminates the processing if the termination has been instructed (Yes).

According to the embodiment described above, the camera 3 is arranged on the external side of the display screen 2a so that the direction of the optical axis A of the camera 3 obliquely intersects the direction of the normal line (normal line B passing through the center of the display screen 2a as an example in the embodiment) passing through the display screen 2a at, for example, about 30° on the front surface side of the display screen 2a. Thus, the range of detecting the hand 7a of the user 7 with which a motion operation is performed can be limited to an area near the device. In other words, the view field of the camera 3 is set so that the hand 7a of the user 7 with which the motion operation is performed or an area near the hand 7a can come within the view field of the camera 3 but a background behind the user 7 cannot come within the view field of the camera 3. Therefore, for example, even if another person cuts across the user 7 at the back, the person is not allowed to come within the shooting range, and erroneous detection caused by the detection of part of the person can be prevented.

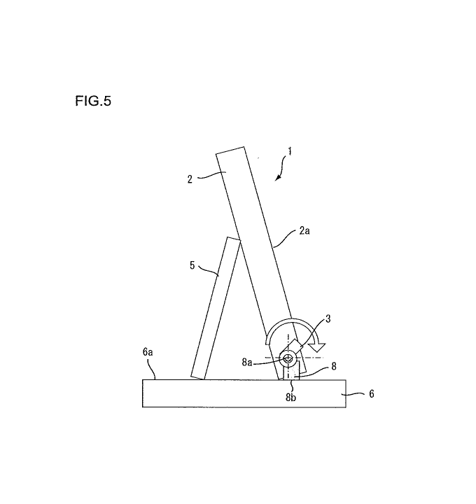

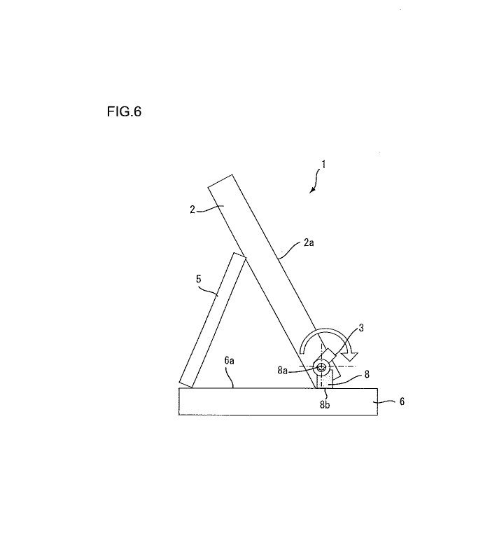

Next, a first modified example of the above digital photo frame 1 will be described with reference to FIGS. 5 and 6. Constituents substantially the same as those of FIGS. 1 to 3 will be denoted by the same symbols, and their descriptions will be omitted. In other words, in the above embodiment, the camera 3 is fixed at the substantially central area of the lower side part of the frame 2b of the display 2. Accordingly, when the angle of the stand 5 is changed to change the inclination of the display screen 2a, the orientation direction of the camera 3 is also changed correspondingly.

Conversely, the first modified example is configured so that the orientation direction of the camera 3 is not changed even if the angle of the stand 5 serving as a display supporting member is changed to change the inclination of the display screen 2a. In other words, the camera 3 is fixed to a camera supporting member 8, and the camera supporting member 8 is rotatably supported via a rotating shaft 8a provided near the lower side of the frame 2b in a direction substantially parallel to the lower side. In addition, the camera supporting member 8 has a certain degree of uneven load that causes the camera 3 to be oriented in a substantially constant direction due to the action of gravity in a state in which the digital photo frame 1 is lifted, and its lower surface serves as a contact surface 8b formed to be flat. When the digital photo frame 1 is mounted on the mounting surface 6a, the contact surface 8b of the camera supporting member 8 comes in contact with the mounting surface 6a to limit the rotation of the camera supporting member 8, whereby the camera 3 is oriented in a constant direction. Thus, for example, even if the inclination of the display 2 is changed so as to create a state shown in FIG. 6 from a state shown in FIG. 5, the orientation direction (direction of the optical axis A) of the camera 3 is not changed, but the camera 3 is oriented in a constant direction.

Note that even in a case in which the inclination of the display 2 is changed with the LED 4 fixed to the camera supporting member 8, the orientation direction (direction of the optical axis) of the LED 4 may be oriented in a constant direction similar to the orientation direction (direction of the optical axis A) of the camera 3.

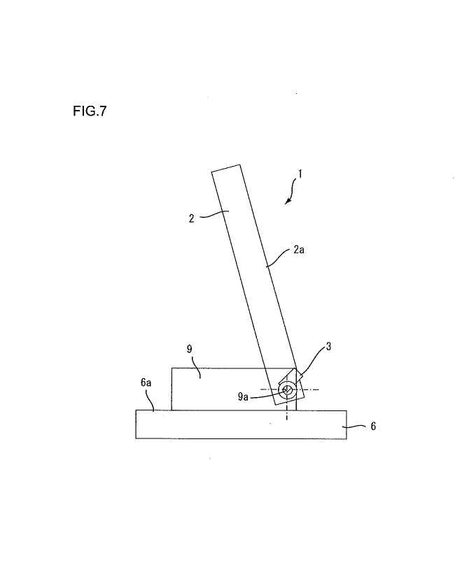

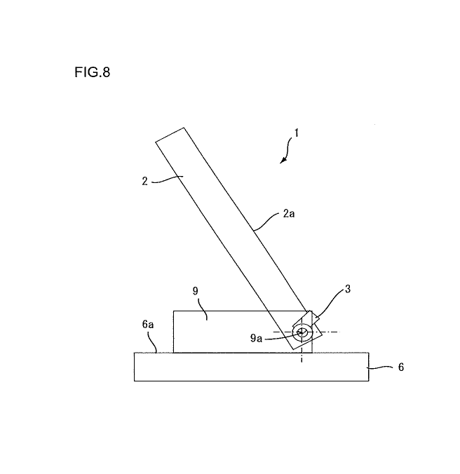

Next, a second modified example of the above digital photo frame 1 will be described with reference to FIGS. 7 and 8. Constituents substantially the same as those of FIGS. 1 to 3 will be denoted by the same symbols, and their descriptions will be omitted. In other words, the second modified example is also configured so that the orientation direction of the camera 3 is not changed even if the inclination of the display screen 2a is changed as is the case with the above first modified example. More specifically, in the second modified example, a base 9 serving as a display supporting member is provided instead of the stand 5, and the display 2 is rotatably supported on the base 9 via a rotating shaft 9a. As for its rotation, the display 2 gets resistance sufficient to keep its own position at a part supported on the base 9, and the position can be changed when the user 7 presses the display 2 with his/her hand. On the other hand, the display 2 keeps the position in a state in which the display 2 is not pressed. The camera 3 is fixed to the base 9 so as to be oriented in a prescribed direction. Thus, for example, even if the inclination of the display 2 is changed so as to create a state shown in FIG. 8 from a state shown in FIG. 7, the orientation direction (direction of the optical axis A) of the camera 3 is not changed, but the camera 3 is oriented in a constant direction.

Note that even in a case in which the inclination of the display 2 is changed with the LED 4 fixed to the base 9 so as to be oriented in a prescribed direction, the orientation direction (direction of an optical axis C) of the LED 4 may be oriented in a constant direction similar to the orientation direction (direction of the optical axis A) of the camera 3.

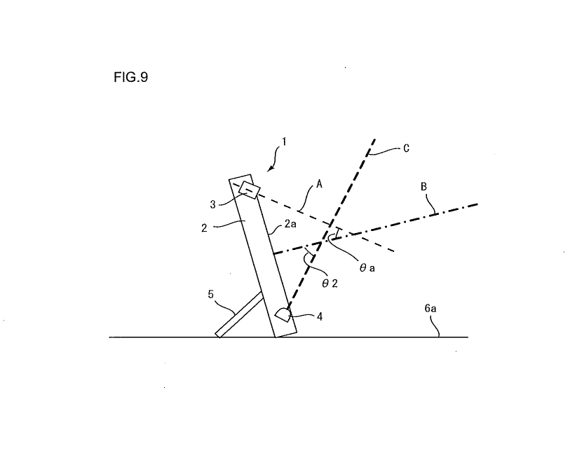

Next, the arrangement of the LED 4 will be described in detail as another embodiment of the present invention. For example, as shown in FIG. 9, the LED 4 can be integrally fixed to the substantially central area of the lower side part of the frame (frame member) arranged at the periphery of the display screen 2a on the front side of the display 2, and arranged on the external side of the display screen 2a so that the direction (orientation direction) of the optical axis C obliquely intersects the direction of the normal line B passing through the display screen 2a on the front surface (front) side of the display screen 2a.

The angle θ2 of the optical axis C of the LED 4 relative to the normal line B passing through the center (or an area near the center) of the display screen 2a is set in the range of, for example, θ2=40°±20°. The angle θ2 is appropriately set according to the size of the display screen 2a of the display 2. The angle θ2 is more preferably set at about θ2=40°±10° and most preferably set at about θ2=40°.

As described above, the LED 4 is arranged so that the direction of the optical axis C obliquely intersects the normal line B passing through the display screen 2a, whereby the hand 7a of the user 7 serving as a detection object with which a motion operation is performed is illuminated by illumination light from the LED 4. However, the physical parts of the user other than the hand 7a and a background behind the user are not illuminated, and the hand 7a serving as a detection object is brightened while the remaining parts are darkened in a shooting image. Therefore, the detection accuracy of the hand 7a can be improved with the setting of an appropriate threshold.

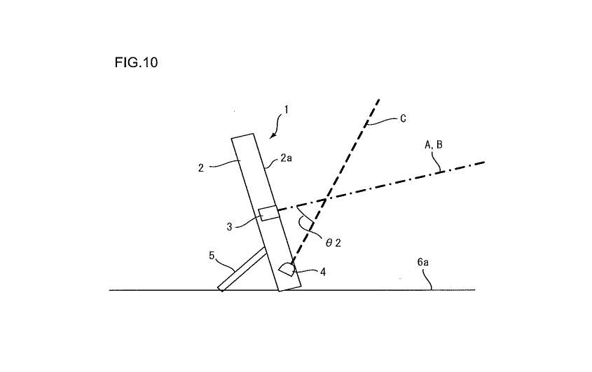

Note that in FIG. 9, the camera 3 is fixed at the substantially central area of the upper side of the frame arranged at the periphery of the display screen 2a. However, as shown in FIG. 10, the camera 3 may be fixed at the substantially central area of the lateral side (left side or right side) of the frame. In addition, although not shown in the figure, the camera 3 and the LED 4 may be reversely arranged in FIG. 9. In other words, the LED 4 may be arranged at the position of the camera 3, and the camera 3 may be arranged at the position of the LED 4. Note that the direction of the optical axis A of the camera 3 in these cases may be substantially parallel to the normal line B passing through the display screen 2a or may obliquely intersect the normal line B as described above.

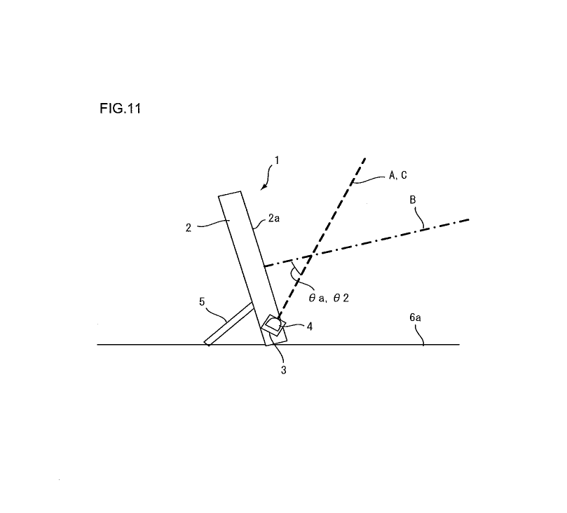

In a case in which both the direction of the optical axis A of the camera 3 and that of the optical axis C of the LED 4 obliquely intersect the normal line B passing through the display screen 2a, the camera 3 and the LED 4 may be arranged adjacent to each other at the substantially central area of the lower side of the frame constituting the periphery of the display screen 2a as shown in, for example, FIG. 11 so that the angle θa of the optical axis A of the camera 3 relative to the normal line B passing through the display screen 2a is set to be substantially equal to the angle θ2 of the optical axis C of the LED 4 relative to the normal line B. Thus, it is possible to synergistically realize the effect of improving the detection accuracy created when the optical axis A of the camera 3 obliquely intersects the normal line B and the effect of improving the detection accuracy created when the optical axis C of the LED 4 obliquely intersects the normal line B.

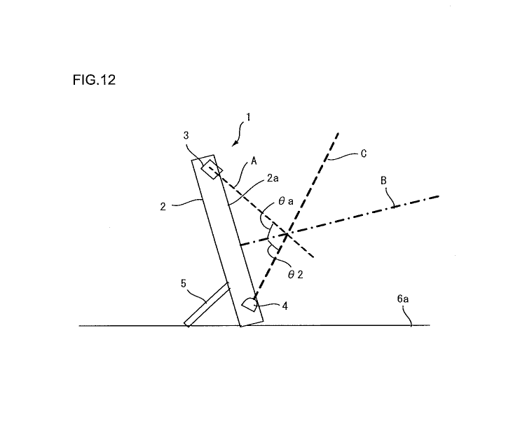

Note that it is also effective to arrange the camera 3 and the LED 4 as shown in FIG. 12 and set the angle θa of the optical axis A of the camera 3 relative to the normal line B passing through the display screen 2a to be substantially equal to the angle θ2 of the optical axis C of the LED 4 relative to the normal line B.

In addition, in a case in which both the direction of the optical axis A of the camera 3 and that of the optical axis C of the LED 4 obliquely intersect the normal line B passing through the display screen 2a, it is preferable to set θ2 to be greater than θa in order to make the angle θa of the optical axis A of the camera 3 relative to the normal line B passing through the display screen 2a and the angle θ2 of the optical axis C of the LED 4 relative to the normal line B different from each other (like, for example, the case as shown in FIG. 9). Here, a relative angular difference (θ2−θa) can be set at about 10°. In this case, it is only necessary to integrally form the camera 3 and the LED 4 as a unit, set the relative angular difference (θ2−θa) at a fixed value, and rotatably support the unit in the frame so that its inclination can be adjusted. The camera 3 or the LED 4 alone may be rotatably supported in the frame so that its inclination can be adjusted.

The adjustment of the inclination of the camera 3, the LED 4, or their integrated unit may be manually performed or may be performed by motor driving or the like. In a case in which the adjustment is performed by the motor driving or the like, an acceleration sensor may be provided in the display 2 to detect the angle of the display screen 2a relative to the mounting surface so that the inclination of the camera 3, the LED 4, or the integrated unit of the camera 3 and the LED 4 can be automatically adjusted according to the detected angle. In addition, the opening/closing angle or the opening/closing position of the stand 5 may be detected to determine whether the mounting surface is a desk, a wall, or the like so that the inclination of the camera 3, the LED 4, or the integrated unit of the camera 3 and the LED 4 can be automatically adjusted according to the detected circumstance. Moreover, an air pressure sensor or the like may be provided to detect the height position of the display 2 so that the inclination of the camera 3, the LED 4, or the integrated unit of the camera 3 and the LED 4 can be automatically adjusted according to the detected height position. The inclination of the camera 3, the LED 4, or the integrated unit of the camera 3 and the LED 4 may be automatically adjusted according to a detected result based on the combinations of the above respective detected results.

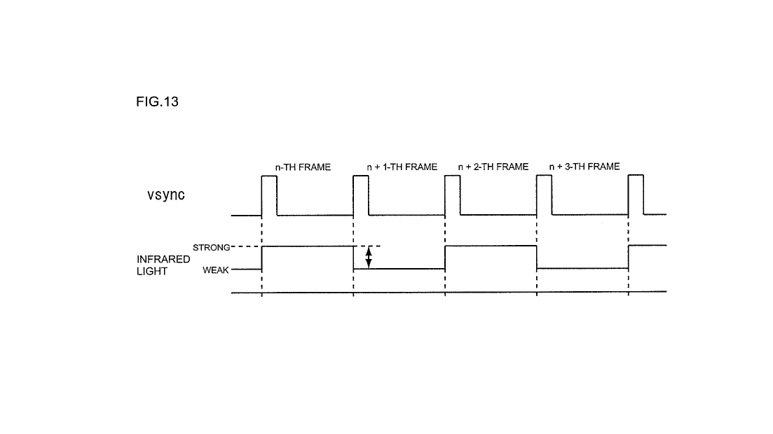

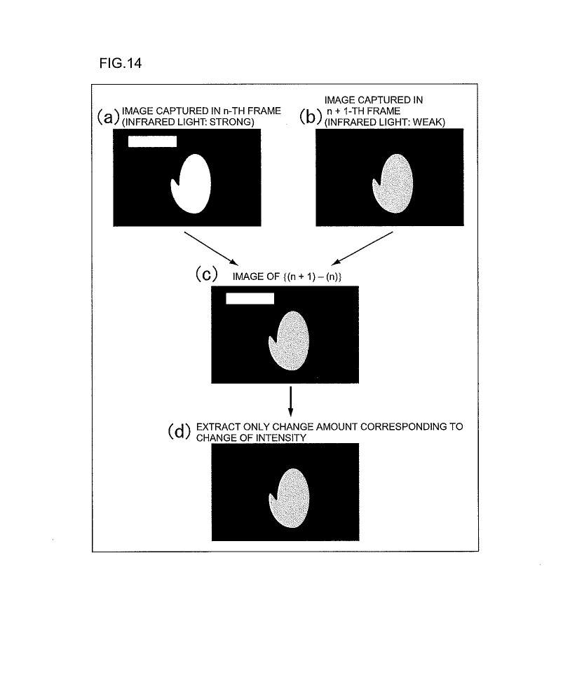

Next, first object detection processing (object detection device) for detecting the hand 7a of the user as a detection object in the image display device of the embodiment will be described with reference to FIGS. 13 and 14.

In FIG. 13, the upper level “vsync” indicates the image capturing timing (the n-th frame, the n+1-th frame, the n+2-th frame, and the n+3-th frame shown from left where n represents 1, 2, 3, etc.,) of an imaging device (image sensor) constituting the camera 3, and the lower level “infrared light” indicates the light-intensity change timing of the illumination light (here, infrared light) of the LED 4.

The control device 11 selectively successively (alternately) performs, in synchronization with the frame rate of the imaging device of the camera 3, the switching control between a strong light emission mode in which voltage is applied to the LED 4 so as to emit light at first light intensity and a weak light emission mode in which voltage is applied to the LED 4 so as to emit light at second light intensity less than the first light intensity and greater than zero light intensity. Here, the zero light intensity indicates a state in which no voltage is applied, i.e., a state in which the LED 4 is caused to turn off. Accordingly, the weak light emission mode does not include the state in which the LED 4 is caused to turn off. Note in the embodiment that, for simplicity, the first light intensity is set at 100% and the second light intensity is set at 50% half the intensity of the first light intensity. In other words, the LED 4 is caused to emit light in the strong light emission mode when an image in the n-th frame is captured, and then caused to emit light in the weak light emission mode when an image in the n+1-th frame is captured. In this manner, the strong light emission mode and the weak light emission mode are successively repeated.

FIGS. 14(a) to 14(d) are diagrams for describing the first object detection processing. FIG. 14(a) schematically shows the image in the n-th frame captured when the LED 4 is caused to emit light in the strong light emission mode (at the first light intensity), and FIG. 14(b) schematically shows the image in the n+1-th frame captured when the LED 4 is caused to emit light in the weak light emission mode (at the second light intensity).

Note that in FIG. 14(a), a laterally elongated rectangle shown at the upper left area indicates light reflected as disturbance when blinking illumination (such as a fluorescent bulb and an inferior LED bulb) lights up. FIG. 14(b) indicates that such disturbance is not reflected since the blinking light source is caused to turn off. A figure substantially like a hand shown at the central area of the image is an image related to the hand 7a of the user as a detection object. FIG. 14(a) shows a state in which the figure is reflected in white (at light intensity of 100%) since the LED 4 is caused to emit light in the strong light emission mode, and FIG. 14(b) shows a state in which the figure is reflected in gray (at light intensity of 50%) since the LED 4 is caused to emit light in the weak light emission mode.

First, the image of the difference {(n+1)−(n)} between the image captured in the n-th frame shown in FIG. 14(a) and the image captured in the n+1-th frame shown in FIG. 14(b) is calculated. The image of the difference is an image obtained by calculating the difference between the brightness values of the corresponding pixels of both images. The image of the difference is shown in FIG. 14(c). At this stage, the disturbance (laterally elongated rectangle) remains since the difference is only calculated. Therefore, in this state, the detection accuracy of the image related to the hand 7a serving as a detection object cannot be sufficiently obtained.

Accordingly, in the first object detection processing, the light intensity of the illumination light is changed to distinguish the area related to the disturbance from the image related to the hand 7a serving as a detection object to eliminate only the disturbance. In other words, as shown in FIG. 14(d), the LED 4 is caused to emit light at the first light intensity (100%) according to the strong light emission mode in the n-th frame, while being caused to emit light at the second light intensity (50%) according to the weak light emission mode in the n+1-th frame. Therefore, the luminance (brightness) of the image related to the hand 7a serving as a detection object becomes approximately equal to {(the second light intensity)−(the first light intensity)}, i.e., 50%-100%=about −50%. Accordingly, it can be determined that the image related to pixels having brightness of about −50% is the image related to the hand 7a serving as a detection object. On the other hand, if the brightness of the disturbance in the n-th frame is, for example, 90%, the brightness of the disturbance in the n+1-th frame is 0%. Therefore, the difference between the second light intensity and the first light intensity becomes 0%−90%=−90%, whereby the image related to the hand 7a serving as a detection object can be distinguished from the image related to the disturbance.

Accordingly, a threshold for extracting the image is set at, for example, −50±10%, and the image related to pixels having brightness not included in this range is deleted as the disturbance. Thus, as shown in FIG. 14(d), an image in which only the image related to the hand 7a is extracted can be captured. Accordingly, the detection accuracy of the image related to the hand 7a serving as a detection object can be improved.

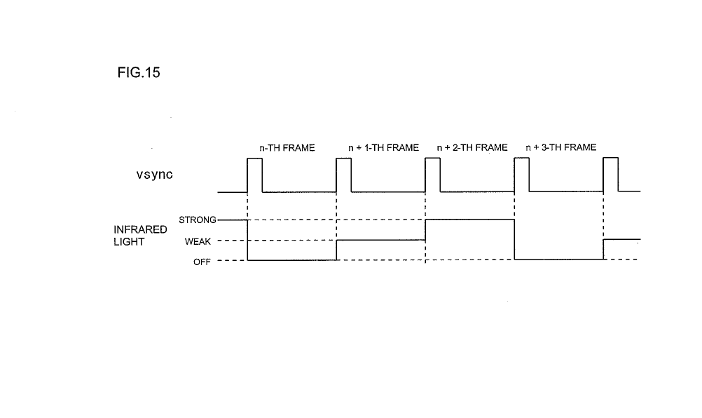

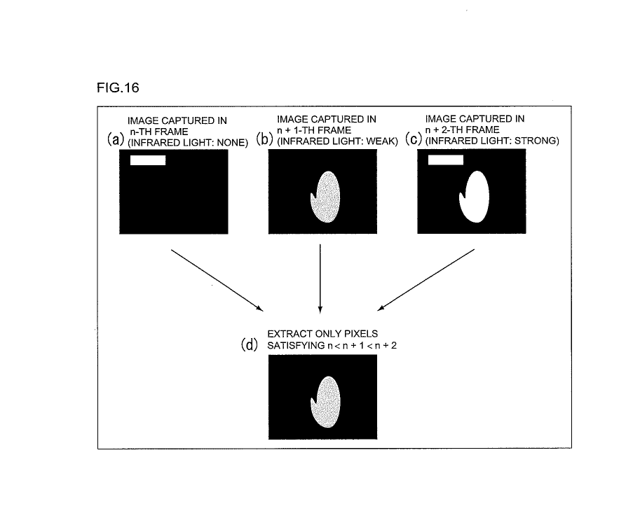

Next, second object detection processing (object detection device) for detecting the hand 7a of the user as a detection object in the image display device of the embodiment will be described with reference to FIGS. 15 and 16.

In FIG. 15, the upper level “vsync” indicates the image capturing timing (the n-th frame, the n+1-th frame, the n+2-th frame, and the n+3-th frame shown from left where n represents 1, 2, 3, etc.,) of an imaging device (image sensor) constituting the camera 3, and the lower level “infrared light” indicates the intensity change timing of the illumination light (here, infrared light) of the LED 4.

The control device 11 selectively successively performs, in synchronization with the frame rate of the imaging device of the camera 3, the switching control between a strong light emission mode in which voltage is applied to the LED 4 so as to emit light at first light intensity, a weak light emission mode in which voltage is applied to the LED 4 so as to emit light at second light intensity less than the first light intensity and greater than zero light intensity, and a turn-off mode in which the light intensity of the LED 4 is zero (i.e., no voltage is applied to the LED 4 to turn off). Here, the LED 4 is caused to repeatedly emit light in the turn-off mode, the weak light emission mode, and the strong light emission mode in this order. Note here that, for simplicity, the first light intensity (strong) is set at 100%, the second light intensity (weak) is set at 50% half the intensity of the first light intensity, and the turn-off indicates zero light intensity. In other words, the LED 4 is caused to turn off when an image in the n-th frame is captured, caused to emit light in the weak light emission mode when an image in the n+1-th frame is captured, and caused to emit light in the strong light emission mode when an image in the n+2-th frame is captured. In this manner, the turn-off mode, the weak light emission mode, and the strong light emission mode are successively repeated.

FIGS. 16(a) to 16(d) are diagrams for describing the second object detection processing. FIG. 16(a) shows the image in the n-th frame captured when the LED 4 is caused to turn off, FIG. 16(b) shows the image in the n+1-th frame captured when the LED 4 is caused to emit light in the weak light emission mode (at the second light intensity), and FIG. 16(c) shows the image in the n+2-th frame captured when the LED 4 is caused to emit light in the strong light emission mode.

Note that in FIGS. 16(a) and 16(c), a laterally elongated rectangle shown at the upper left area indicates light reflected as disturbance when blinking illumination (such as a fluorescent bulb and an inferior LED bulb) lights up. FIG. 16(b) indicates that such disturbance is not reflected since the blinking illumination is caused to turn off. A figure substantially like a hand shown at the central area of the image is an image related to the hand 7a of the user as a detection object. FIG. 16(a) shows a state in which the figure is hardly reflected since the LED 4 is caused to turn off, FIG. 16(b) shows a state in which the figure is reflected in gray (at light intensity of 50%) since the LED 4 is caused to emit light in the weak light emission mode, and FIG. 16(c) shows a state in which the figure is reflected in white (at light intensity of 100%) since the LED 4 is caused to emit light in the strong light emission mode.

When attention is paid to the n-th to the n+2-th frames, the area (pixels) related to the hand 7a serving as a detection object illuminated by the LED 4 changes stepwise (here, brightens) according to the change of the light emission intensity of the LED 4. Accordingly, the images related to the three frames, i.e., the image captured in the n-th frame shown in FIG. 16(a), the image captured in the n+1-th frame shown in FIG. 16(b), and the image captured in the n+2-th frame shown in FIG. 16(c) are compared with each other to extract only the values of the pixels satisfying (n<n+1<n+2), whereby the disturbance can be eliminated.

In the above second object detection processing, the LED 4 is caused to emit light (or caused to turn off) in the three modes of the strong light emission mode, the weak light emission mode, and the turn-off mode. However, with the setting of a mode in which the LED 4 is caused to emit light at light intensity between the strong light emission mode and the weak light emission mode and/or a mode in which the LED 4 is caused to emit light at light intensity between the weak light emission mode and the turn-off mode or the like, images related to four or more frames may be used. In addition, instead of omitting the turn-off mode, it may also be possible to set a mode in which the LED 4 is caused to emit light at third light intensity less than the second light intensity related to the weak light emission mode.

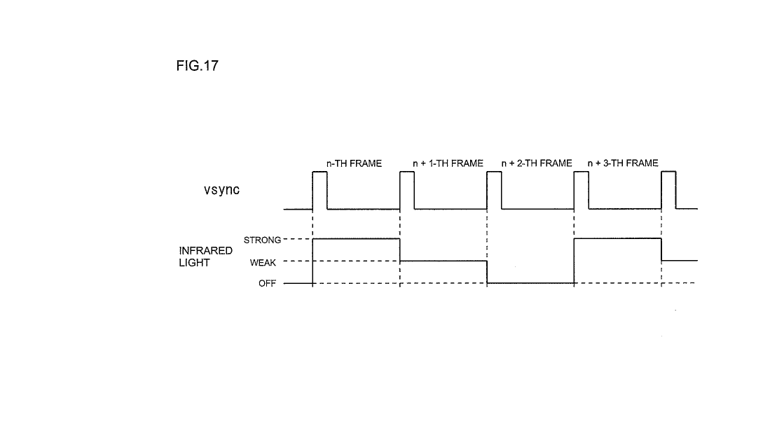

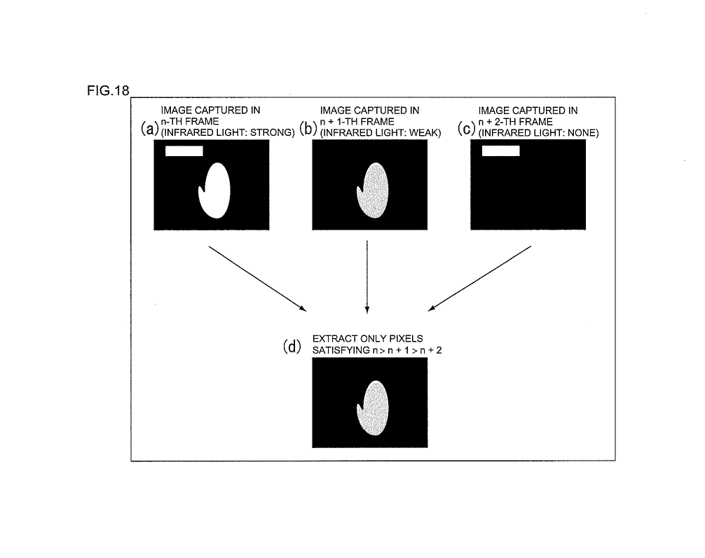

Here, as shown in FIGS. 17 and 18, the light emission (the change of the light intensity) of the LED 4 may be performed in the order reverse to that of the above. In other words, the LED 4 may be caused to repeatedly emit light in the strong light emission mode, the weak light emission mode, and the turn-off mode in this order. Since processing in this case is the same as that shown in FIGS. 15 and 16, its description will be omitted. Note that in this case, the images related to the three frames, i.e., the image captured in the n-th frame shown in FIG. 18(a), the image captured in the n+1-th frame shown in FIG. 18(b), and the image captured in the n+2-th frame shown in FIG. 18(c) are compared with each other to extract only the values of the pixel values satisfying (n>n+1>n+2), whereby the disturbance can be eliminated.

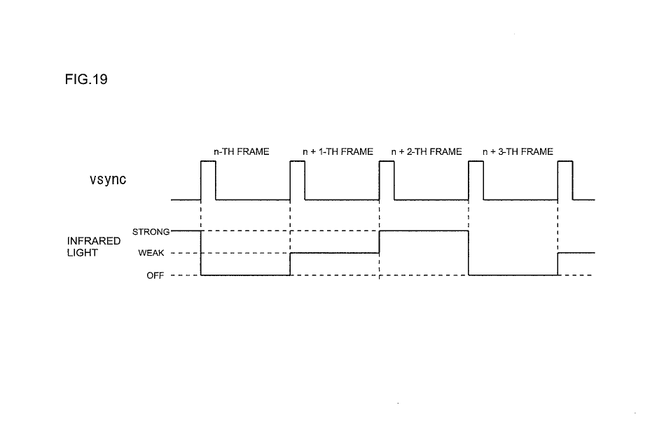

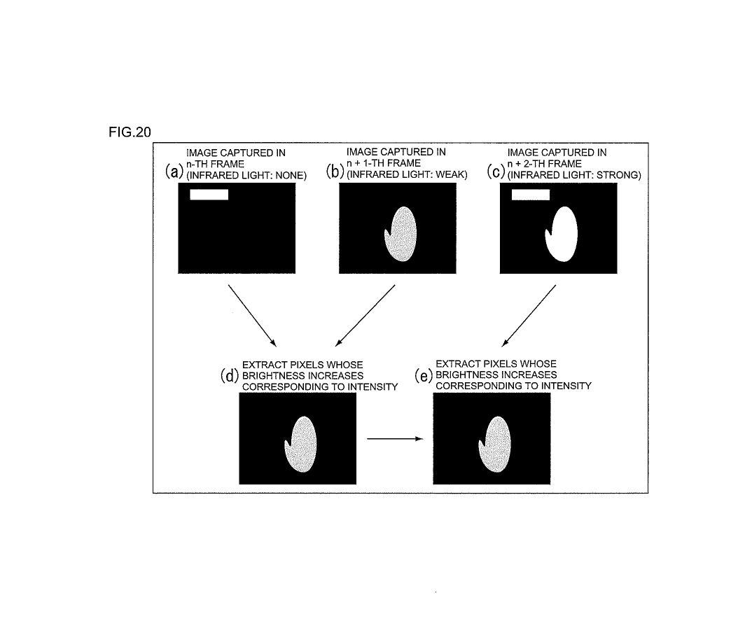

Next, third object detection processing (object detection device) for detecting the hand 7a of the user as a detection object in the image display device of the embodiment will be described with reference to FIGS. 19 and 20.

In FIG. 19, the upper level “vsync” indicates the image capturing timing (the n-th frame, the n+1-th frame, the n+2-th frame, and the n+3-th frame shown from left where n represents 1, 2, 3, etc.,) of an imaging device (image sensor) constituting the camera 3, and the lower level “infrared light” indicates the light-intensity change timing of the illumination light (here, infrared light) of the LED 4.

The control device 11 selectively successively performs, in synchronization with the frame rate of the imaging device of the camera 3, the switching control between a strong light emission mode in which voltage is applied to the LED 4 so as to emit light at first light intensity, a weak light emission mode in which voltage is applied to the LED 4 so as to emit light at second light intensity less than the first light intensity and greater than zero light intensity, and a turn-off mode in which the light intensity of the LED 4 is zero (i.e., no voltage is applied to the LED 4 to turn off). Here, the LED 4 is caused to repeatedly emit light in the turn-off mode, the weak light emission mode, and the strong light emission mode in this order. Note in the embodiment that, for simplicity, the first light intensity is set at 100%, the second light intensity is set at 50% half the intensity of the first light intensity, and the turn-off indicates zero light intensity. In other words, the LED 4 is caused to turn off when an image in the n-th frame is captured, caused to emit light in the weak light emission mode when an image in the n+1-th frame is captured, and caused to emit light in the strong light emission mode when an image in the n+2-th frame is captured. In this manner, the turn-off mode, the weak light emission mode, and the strong light emission mode are successively repeated.

FIGS. 20(a) to 20(d) are diagrams for describing the third object detection processing. FIG. 20(a) shows the image in the n-th frame captured when the LED 4 is caused to turn off, FIG. 20(b) shows the image in the n+1-th frame captured when the LED 4 is caused to emit light in the weak light emission mode (at the second light intensity), and FIG. 20(c) shows the image in the n+2-th frame captured when the LED 4 is caused to emit light in the strong light emission mode.

Note that in FIGS. 20(a) and 20(c), a laterally elongated rectangle shown at the upper left area indicates light reflected as disturbance when blinking illumination (such as a fluorescent bulb and an inferior LED bulb) lights up. FIG. 20(b) indicates that such disturbance is not reflected since the blinking illumination is caused to turn off. A figure substantially like a hand shown at the central area of the image is an image related to the hand 7a of the user as a detection object. FIG. 20(a) shows a state in which the figure is hardly reflected since the LED 4 is caused to turn off, FIG. 20(b) shows a state in which the figure is reflected in gray (at light intensity of 50%) since the LED 4 is caused to emit light in the weak light emission mode, and FIG. 20(c) shows a state in which the figure is reflected in white (at light intensity of 100%) since the LED 4 is caused to emit light in the strong light emission mode.

In the above second object detection processing, the pixels are extracted according to the magnitude relationship of the brightness change between the images related to the three frames to detect the object. However, in the third object detection processing, pixels to be extracted are selected according to the change ratio (here, for example, the ratio corresponding to the increased amount) of the light emission intensity of the LED 4.

First, the difference between the image captured in the n-th frame shown in FIG. 20(a) and the image captured in the n+1-th frame shown in FIG. 20(b) is calculated to capture only an area in which the brightness of the image increases at a ratio corresponding to the increased amount of the light emission intensity. In order to eliminate noise (for example, blinking illumination light) contained in this image, a difference is further calculated using the image captured in the n+2-th frame. In this case also, the pixels in which the brightness increases at a ratio corresponding to the increased amount of the light emission intensity are extracted, whereby only the object can be extracted. With the above processing, the detection accuracy of the object can be further improved.

Note that the above first to third object detection processing may be selectively performed according to the properties of disturbance caused by a blinking light source or the like. For example, a brightness sensor may be provided as an illumination properties detection part that detects the properties of illumination (such as a blinking light source) existing in the view field of the camera 3 to detect the blinking frequency of the blinking light source and automatically select and perform the optimum one of the first to third object detection processing based on the detected frequency. Instead of using such a brightness sensor, it may also be possible to detect the properties of illumination (such as a blinking light source) existing in a view field based on an image shot by the camera 3.

The above embodiments describe the case in which the digital photo frame is used as the image display device. However, the present invention can also be applied to other equipment including a camera for motion detection and a display and having an image reproduction function, for example, a personal computer, a tablet computer, a digital camera, a mobile phone, a PDA, a digital television receiver, or the like.

Note that the above embodiments are described to facilitate the understanding of the present invention and are not described to limit the present invention. Accordingly, the respective elements disclosed in the above embodiments are intended to contain all the design changes and equivalents belonging to the scope of the present invention.

1. An image display device, comprising:
a display having a display screen;
a shooting unit that is arranged on an external side of the display screen so that an optical axis obliquely intersects a normal line of the display screen on a front surface side of the display screen and sequentially shoots images in a direction of the optical axis to capture shooting images; and
a detection unit that detects a change of the shooting images shot by the shooting unit.

2. The image display device according to claim 1, further comprising:
an illumination unit that emits infrared light as illumination light for shooting with the shooting unit.

3. The image display device according to claim 2, wherein
the detection unit detects the change of the shooting images based on a difference between the shooting image shot by the shooting unit in a state in which the illumination unit is caused to illuminate and the shooting image shot by the shooting unit in a state in which the illumination unit is not caused to illuminate.

4. The image display device according to claim 1, further comprising:
a display supporting member that supports the display so that an inclination of the display screen relative to a mounting surface is capable of being changed, wherein
the shooting unit is fixed to a supporting member rotatably supported in the display, and
the supporting member has a contact surface that comes in contact with the mounting surface when the display is mounted on the mounting surface and limits a rotating position thereof so that the shooting unit is oriented in a constant direction irrespective of an inclination of the display relative to the mounting surface.

5. The image display device according to claim 1, further comprising:
a display supporting member that supports the display so that an inclination of the display screen relative to a mounting surface is capable of being changed, wherein
the shooting unit is fixed to the display supporting member so as to be oriented in a constant direction irrespective of an inclination of the display relative to the mounting surface.

6. The image display device according to claim 1, wherein
the display screen has a substantially rectangular shape, and
the shooting unit is arranged at a substantially central area near a lower side of the display screen.

7. A digital photo frame, comprising:
the image display device according to claim 1.

8. An image display device, comprising:
a display having a display screen;
an illumination unit arranged on an external side of the display screen so that a light beam of illumination light obliquely intersects a normal line of the display screen on a front surface side of the display screen; and
a shooting unit that sequentially shoots images in a front surface direction of the display screen to capture shooting images.

9. The image display device according to claim 8, wherein
the illumination unit emits infrared light.

10. The image display device according to claim 8, wherein
the shooting unit is arranged on the external side of the display screen so that an optical axis obliquely intersects the normal line of the display screen on the front surface side of the display screen.

11. The image display device according to claim 10, further comprising:
a detection unit that detects a change of the shooting images shot by the shooting unit, wherein
the detection unit detects the change of the shooting images based on a difference between the shooting image shot by the shooting unit in a state in which the illumination unit is caused to illuminate and the shooting image shot by the shooting unit in a state in which the illumination unit is not caused to illuminate.

12. The image display device according to claim 8, further comprising:
a display supporting member that supports the display so that an inclination of the display screen relative to a mounting surface is capable of being changed, wherein
the shooting unit is fixed to a supporting member rotatably supported in the display, and
the supporting member has a contact surface that comes in contact with the mounting surface when the display is mounted on the mounting surface and limits a rotating position thereof so that the shooting unit is oriented in a constant direction irrespective of an inclination of the display relative to the mounting surface.

13. The image display device according to claim 8, further comprising:
a display supporting member that supports the display so that the inclination of the display screen relative to the mounting surface is capable of being changed, wherein
the illumination unit is fixed to the display supporting member so as to be oriented in a constant direction irrespective of the inclination of the display relative to the mounting surface.

14. The image display device according to claim 8, wherein
the display screen has a substantially rectangular shape, and
the illumination unit is arranged at a substantially central area near a lower side of the display screen.

15. A digital photo frame, comprising:
the image display device according to claim 8.

16. An object detection device, comprising:
a shooting unit that sequentially shoots images at a prescribed frame rate to capture shooting images;
an illumination unit that emits illumination light for shooting with the shooting unit; and
a control unit that performs switching control so that the illumination unit selectively emits light between at first light intensity and at second light intensity less than the first light intensity.

17. The object detection device according to claim 16, wherein
the illumination unit emits infrared light.

18. The object detection device according to claim 16, wherein
the control unit performs the switching control in synchronization with the frame rate.

19. The object detection device according to claim 16, further comprising:
a detection unit that detects a change of the shooting images shot by the shooting unit, wherein
the detection unit detects the change of the shooting images based on a difference between the shooting image shot by the shooting unit in a state in which the illumination unit is caused to illuminate at the first light intensity and the shooting image shot by the shooting unit in a state in which the illumination unit is caused to illuminate at the second light intensity.

20. The object detection device according to claim 16, further comprising:
a detection unit that detects a change of the shooting images shot by the shooting unit, wherein
the detection unit detects the change of the shooting images based on a difference between the shooting image shot by the shooting unit in a state in which the illumination unit is caused to illuminate at the first light intensity and the shooting image shot by the shooting unit in a state in which the illumination unit is caused to illuminate at the second light intensity and based on a ratio of the first light intensity to the second light intensity.

21. The object detection device according to claim 16, wherein
the control unit successively performs the switching control at the first light intensity, the second light intensity, and a third light intensity in this order or at the third light intensity, the second light intensity, and the first light intensity in this order so that the illumination unit selectively emits light at the first light intensity, the second light intensity, and the third light intensity less than the second light intensity.

22. The object detection device according to claim 21, wherein
the third light intensity represents zero light intensity.

23. The object detection device according to claim 21, further comprising:
a detection unit that detects a change of the shooting images shot by the shooting unit, wherein
the detection unit detects a part changing with a transition between the first light intensity, the second light intensity, and the third light intensity as the change of the shooting images among the shooting image shot by the shooting unit in a state in which the illumination unit is caused to illuminate at the first light intensity, the shooting image shot by the shooting unit in a state in which the illumination unit is caused to illuminate at the second light intensity, and the shooting image shot by the shooting unit in a state in which the illumination unit is caused to illuminate at the third light intensity.

24. The object detection device according to claim 21, further comprising:
a change detection unit that detects a change of the shooting images shot by the shooting unit; and
an illumination properties detection unit that detects properties of illumination existing in a view field of the camera, wherein
the change detection unit selectively performs any of
a first mode in which the change of the shooting images is detected based on a difference between the shooting images shot by the shooting unit in a state in which the illumination unit is caused to illuminate at the first light intensity and the shooting image shot by the shooting unit in a state in which the illumination unit is caused to illuminate at the second light intensity,
a second mode in which the change of the shooting images is detected based on the difference between the shooting image shot by the shooting unit in a state in which the illumination unit is caused to illuminate at the first light intensity and the shooting image shot by the shooting unit in a state in which the illumination unit is caused to illuminate at the second light intensity and based on a ratio of the first light intensity to the second light intensity, and
a third mode in which a part changing with a transition between the first light intensity, the second light intensity, and the third light intensity is detected as the change of the shooting images among the shooting image shot by the shooting unit in a state in which the illumination unit is caused to illuminate at the first light intensity, the shooting image shot by the shooting unit in a state in which the illumination unit is caused to illuminate at the second light intensity, and the shooting image shot by the shooting unit in a state in which the illumination unit is caused to illuminate at the third light intensity, and
the control unit determines the mode to be performed by the change detection unit based on a detection result of the illumination properties detection unit.

25. An image display device, comprising:
a display having a display screen; and
the object detection device according to claim 16.

26. The image display device according to claim 25, wherein
the shooting unit is arranged on an external side of the display screen so that an optical axis obliquely intersects a normal line of the display screen on a front surface side of the display screen.

27. The image display device according to claim 25, wherein
the illumination unit is arranged on the external side of the display screen so that a light beam of the illumination light obliquely intersects the normal line of the display screen on the front surface side of the display screen.

28. A digital photo frame, comprising:
the image display device according to claim 25.
